(19) United States
(12) Patent Application Publication
(10) Pub. No.: US 2004/0107365 A1
(43) Pub. Date: Jun. 3, 2004

(54) System and method for remote website content management and administration

(76) Inventor: Jim R. Hogg, Dripping Springs, TX (US)

Correspondence Address: Koestner Bertani LLP, P.O. Box 26780, Austin, TX, 75755, US

(21) Appl. No.: 10/654,697

(22) Filed: Sep. 4, 2003

Related U.S. Application Data
(60) Provisional application No. 60/408,024, filed on Sep. 4, 2002.
(60) Provisional application No. 60/408,438, filed on Sep. 5, 2002.

(51) Int. Cl. H04K 1/00; H04L 9/00

(52) U.S. Cl. 713/201; 713/182

(57) ABSTRACT

The present invention allows for the remote creation of web folders by a webmaster. In doing so, the responsibility of this web folder administration is assigned to a local administrator who remotely manages and assigns users the ability to upload web content. These users are either “filtered” or “non-filtered” users. Non-filtered users have the ability to upload web content directly to their website (Internet or intranet) without the local administrator's review. Filtered users also have the ability to upload web content onto the server. However, this content is not immediately available on the network to the public at large. Until this content has been approved, only the logged-on local administrator can review this filtered content. This content can be deleted from the server, approved, or left alone. On approval of the filtered web content by the local administrator, this web content is uploaded to the URL in its proper place and then can be viewed by all on the Internet.

### CROSS REFERENCES TO RELATED APPLICATIONS

This application claims priority of U.S. Provisional Application Serial No. 60/408,024, filed Sep. 4, 2002 and claims priority to U.S. Provisional Application Serial No. 60/408,438 filed Sep. 5, 2002, both entitled “System and Method for Remote Website Content Management and Administration,” by Jim Hogg.

### TECHNICAL FIELD OF THE INVENTION

The present invention relates generally to a method of administering access to web folders. More specifically, the present invention provides a method through which web administrators may remotely assign access rights to users that govern the user's ability to further delegate access rights and to upload content for public display through the internet.

### BACKGROUND OF THE INVENTION

Webmasters spend a great deal of time uploading content to websites. For example, at a school, if every teacher requested that their daily homework assignments be uploaded to the schools website, the webmaster would spend an inordinate amount of time loading these documents and be unavailable for other projects. This situation is true of any enterprise that desires to regularly facilitate communications between members and the public.

Therefore a need exists for a system to simplify the process for computer novices and facilitate the upload of content while preserving a measure of control over the access rights of individual users and the content they intend to publish.

### SUMMARY OF THE INVENTION

The present invention allows for the remote creation of web folders by a webmaster. In doing so, the responsibility of this web folder administration is assigned to a local administrator. This local administrator remotely manages and assigns users the ability to upload web content. These users are either “filtered” or “non-filtered” users. Non-filtered users have the ability to upload web content directly to their website (Internet or intranet) without the local administrator's review. Filtered users also have the ability to upload web content onto the server. However, this content is not immediately available on the network to the public at large. Until this content has been approved, only the logged-on local administrator can review this filtered content. This content can be deleted from the server, approved, or left alone. On approval of the filtered web content by the local administrator, this web content is uploaded to the URL in its proper place and then can be viewed by all on the Internet. Individuals (webmasters, local administrators and filtered or non-filtered users) need to access their respective control panels within the present invention. These three requirements include: a network connection, a capable web browser, and their respective login URL and login information.

### BRIEF DESCRIPTION OF THE DRAWINGS

FIG. 1 depicts the users associated with the present invention.

FIG. 2 depicts the architecture of one implementation of the present invention.

FIGS. 3A-3E depict the various web folders associated with the present invention.

### DESCRIPTION OF INVENTION

One embodiment provides a software system that allows a webmaster to remotely create web folders and assign the rights of each new web folder to a local administrator. This ability to delegate these controls greatly reduces the workload on the webmaster. These local administrators in turn can remotely assign content pages to remote users, filtered or non-filtered. Non-filtered users may directly upload content to a network (internet or intranet) site. The filtered user's content is uploaded to a temporary location where it awaits approval by the local administrator prior to being made available to network users.

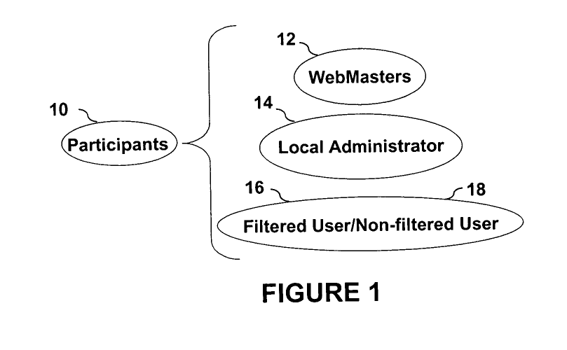

These users are depicted in FIG. 1. In this hierarchy, participants 10 include webmasters 12, local administrators 14, filtered users 16 and non-filtered users 18. Each local administrator may have multiple folders and grant varying access rights to each user. Additionally, each users may have multiple pages within multiple folders wherein each folder may be administered by a single local administrators.

Instructions or code resident on a network server allows webmaster 12 or web administrators to remotely assign access rights to local administrators 14 who in turn remotely assign access rights to the filtered users 16 and non-filtered users 18. Remote access allows the web administrators 12, local administrators 14, filtered users 16 and non-filtered users 18 to fully exercise their rights from any network connection.

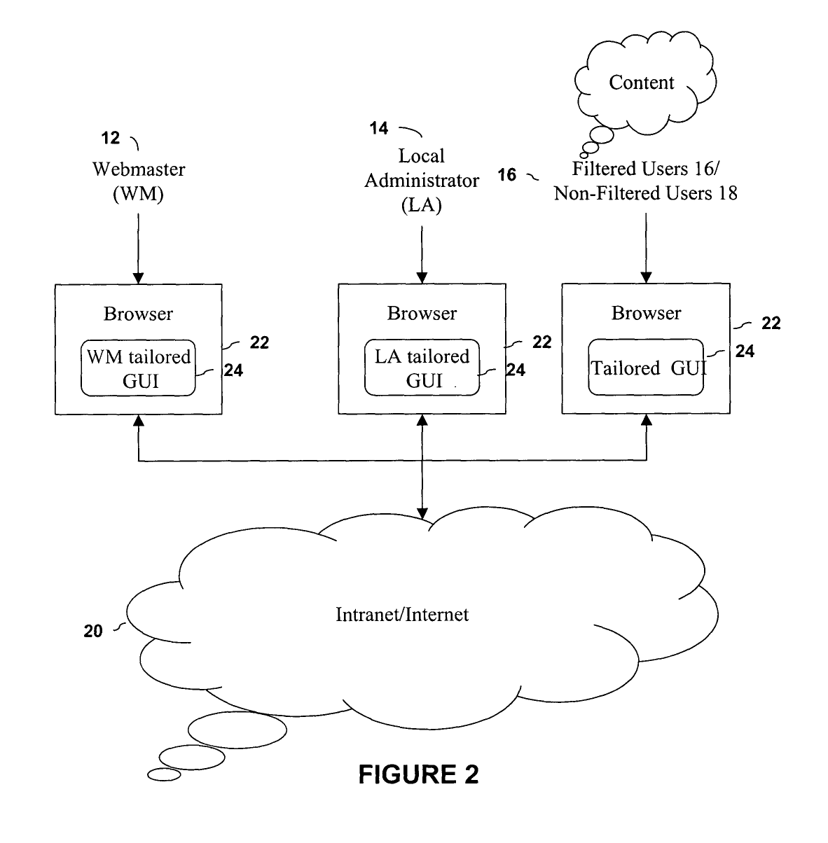

FIG. 2 depicts the architecture of one implementation of the present invention. Here, webmaster 12 accesses the software application provided by the present invention over a network connection 20 with a compatible browser 22. A control panel or dash-board 24 tailored to the webmasters' needs is accessed by web browser 22.

Control panels or GUI's 24 are tailored to the individual's assigned abilities. Webmaster's control panel (GUI 24) allows webmaster 12 to remotely create, assign, and remove web folders and any subordinate local administrator's 14 responsibility of said folders.

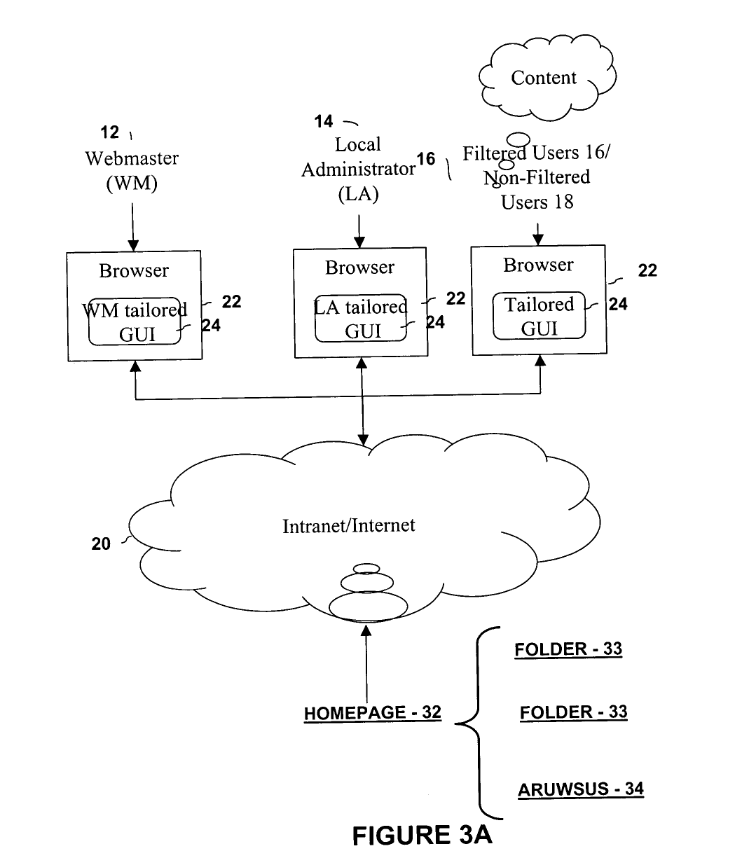

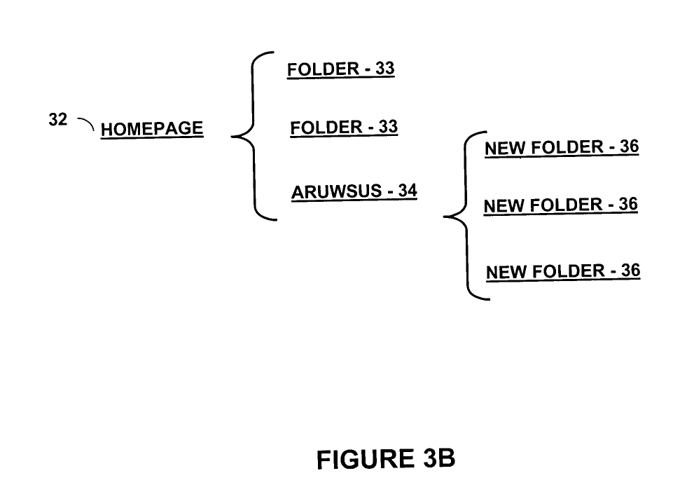

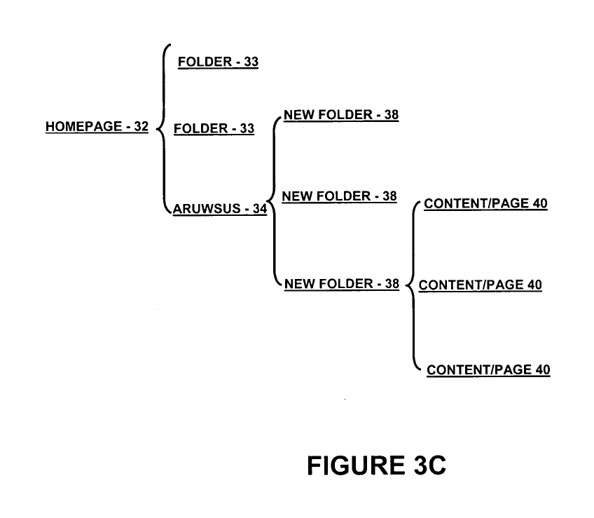

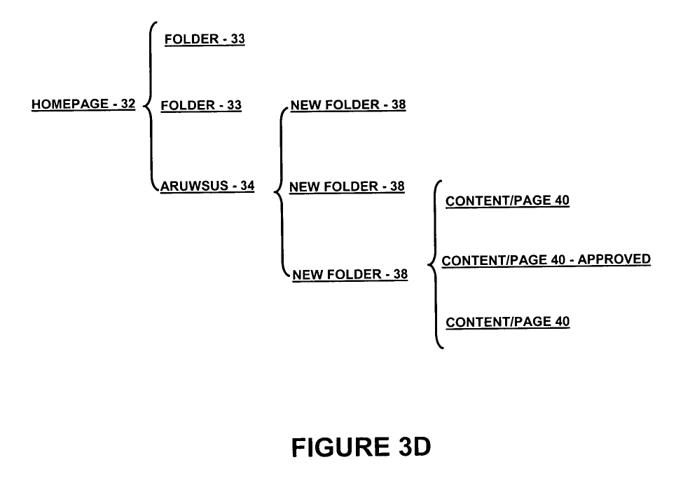

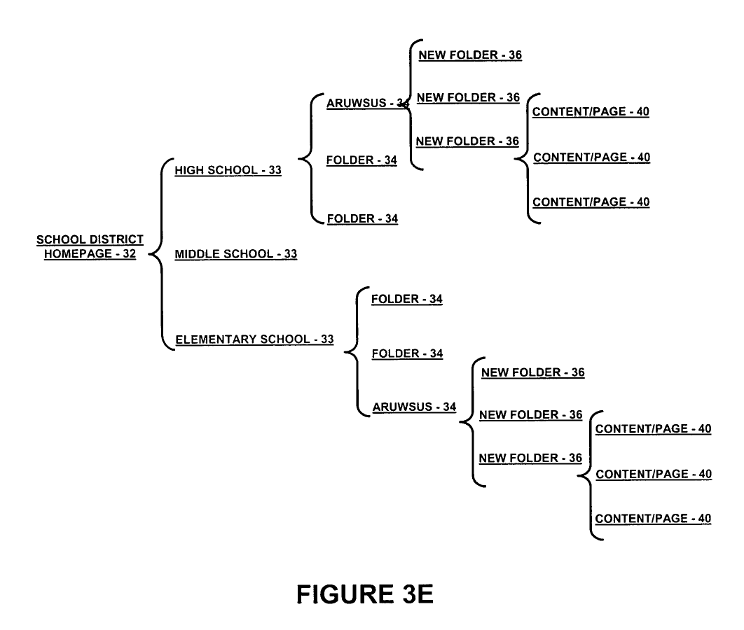

FIG. 3A depict directory trees of web folders provided in one embodiment. FIG. 3A shows a series of top level folders 33 associated with a home page 32. FIGS. 3B-3D provides a Type 1 example having only one top level folder. FIG. 3B depicts new folders 36 created under “ARUWSUS” folder 34 by webmaster 12 for individual local administration.

Web content is uploaded by the filtered or non-filtered users which is approved, if necessary, by the appropriate local administrator 14 prior to being publicly available to all network users as illustrated in FIG. 3D. Local administrators may remotely add and remove users, both filtered and non-filtered. Additionally, local administrators have the ability to remove both filtered or non-filtered users' web content and access. Filtered content also must be approved by the local administrator as illustrated in FIG. 3D.

FIG. 3E provides a Type II example which has more than one top level folder. Depicted here is one instance where Homepage 32 belongs to a school district. As shown, folders 33 each represent an individual school or class of schools, such as High School, Middle School, and Elementary School. Within each school's folder a web administrator maintains a top level folder which is here named “ARUWSUS.” Within each top level folder, each web administrator may assign rights to local administrators. As described above, the local administrators may then assign filtered and non-filtered users access to upload content or pages 40.

Referring to FIG. 2, both filtered users 16 and non-filtered users 18, through their control panel (GUI) 24, have the ability to add, modify, update and/or remove their respective uploaded web content. In one embodiment, a set of software instructions, which, once installed, grants remote access logon to webmaster 12 and ignores no FTP tools in its operation. In fact, to use any FTP tool with the web folder causes software errors to occur, as the database tables would be inaccurate. This system can work with any web URL, and does not affect any existing or new web content NOT located within the top level web folder. The only stipulation is that the web URL cannot have a pre-existing first level web folder named “/ARUWSUS/” or other like predetermined name.

The process allows the use of any type of viewable web content or extension. However, one embodiment default is to only use “.html” type web page extensions. Any uploading attempt of a web page, regardless of user type, may be screened for bad words and commands prior to loading. Bad word screening is obvious in nature, while command blocking helps prevent hacking.

Web administrators have the ability to delegate web folder management to the local administrators. Local administrators assign users the ability to update, upload data to the web folders. From the user's perspective, one needs no special knowledge for web page coding. If the user knows how to copy and paste content, or type web page coding, the user can successfully submit and update web content. Users may choose either manual or automatic update process. Users may submit any or partial web page coding. The more an assigned user learns about web page coding, obviously the better the appearance and result of their web page. However, a user only needs to know their respective login URL and login information, and the ability to click the mouse and type on the keyboard.

The present invention automatically creates and updates an index with titles for both the top level, “/ARUWSUS/”, web folder and each web folder and content created within the top level folder. Thus, only one link is needed to the main “/ARUWSUS/” index from the base site or index.

This process may include additional features such as optional emailing to users of their URL login page and login information, IP blocking of repeated login failures, host URL verification, and etc.

A great deal of compatibility is provided by the fact that these instructions may be written in capable programming language either compiled or scripted and utilize any database capable of Internet queries. For example, one embodiment uses PHP and MySQL, both of which are free for downloading and can be installed on any server. However, the present invention may use any similar combination known to those skilled in the art.

The present invention allows for the remote creation of web folders by a webmaster. In doing so, the responsibility of this web folder administration is assigned to a local administrator. This local administrator remotely manages and assigns users the ability to upload web content. These users are either “filtered” or “non-filtered” users. Non-filtered users have the ability to upload web content directly to their website (Internet or intranet) without the local administrator's review. Filtered users also have the ability to upload web content onto the server. However, this content is not immediately available on the network to the public at large. Until this content has been approved, only the logged-on local administrator can review this filtered content. This content can be deleted from the server, approved, or left alone. On approval of the filtered web content by the local administrator, this web content is uploaded to the URL in its proper place and then can be viewed by all on the Internet.

Individuals (webmasters, local administrators and filtered or non-filtered users) need to access their respective control panels within the present invention. These three requirements include: a network connection, a capable web browser, and their respective login URL and login information.

Although the present invention has been described in detail, it should be understood that various changes, substitutions, and alterations can be made hereto without disporting from the spirit and scope of the invention as defined by the appended claims.

What is claimed:

1. A method of administering access to web folders, comprising:
creating at least one top level web folder administered by a webmaster that assigns access rights to local administrators;
creating at least one local folder, administered by the local administrators, that contains at least one content page;
creating individual users that are assigned individual access rights by the local administrator, wherein these access rights govern the ability to create and modify content for the at least one content page; and
facilitating individual users' ability to create and modify content for the at least one content page, wherein published content of the at least one content page is publicly accessible over the internet.

2. The method of claim 1, wherein the webmaster assigns access rights to the local administrators remotely.

3. The method of claim 2, wherein the local administrators assign access rights to the individual users remotely.

4. The method of claim 3, wherein the individual users remotely access the at least one content page to create and modify content.

5. The method of claim 4, wherein the individual users further comprise filtered users and unfiltered users.

6. The method of claim 5, wherein the local administrators approve content modified or created by the filtered users prior to making the content modified or created by the filtered users publicly available.

7. The method of claim 2, wherein remotely comprises accessing an internet connection through which the webmaster assigns access rights to local administrators.

8. A method of administering access to web folders, comprising:
creating a top level web folder administered by a webmaster that assigns access rights to local administrators either locally or remotely;
creating at least one local folder, administered by the local administrators, that contains at least one content page;
creating individual users that are assigned individual access rights by the local administrator either locally or remotely, wherein these access rights govern the ability to create and modify content for the at least one content page either locally or remotely; and
facilitating individual users' ability to create and modify content for the at least one content page, wherein published content of the at least one content page is publicly accessible over the internet.

9. The method of claim 8, wherein the individual users further comprise filtered users and unfiltered users.

10. The method of claim 8, wherein the local administrators approve content modified or created by the filtered users prior to making the content modified or created by the filtered users publicly available.

11. The method of claim 8, wherein a Graphic User Interface (GUI), customized for the web administrator, local administrator and individual users.

12. The method of claim 11 wherein the GUI facilitates approval of content modified or created by the filtered users and making the content modified or created by the filtered users publicly available.

13. The method of claim 11, wherein the GUI facilitates local administrators in creating individual users, creating content folders, and reviewing content.

14. The method of claim 11, publicly available of their ability to carry out functions under their access rights.

15. The method of claim 11 to create local administrators, wherein remotely comprises accessing an internet connection through which the webmaster assigns access rights to local administrators.
